(19) United States
(12) Patent Application Publication
(10) Pub. No.: US 2016/0227868 A1
(43) Pub. Date: Aug. 11, 2016

(54) REMOVABLE FACE SHIELD FOR AUGMENTED REALITY DEVICE

(71) Applicants: BRIAN MULLINS, SIERRA MADRE, CA (US); MATTHEW KAMMERAIT, WEST HOLYWOOD, CA (US); TIMOTHEOS LEAHY, LOS ANGELES, CA (US)

(72) Inventors: BRIAN MULLINS, SIERRA MADRE, CA (US); MATTHEW KAMMERAIT, WEST HOLYWOOD, CA (US); TIMOTHEOS LEAHY, LOS ANGELES, CA (US)

(73) Assignee: DAQRI, LLC, LOS ANGELES, CA (US)

(21) Appl. No.: 15/018,009

(22) Filed: Feb. 8, 2016

Related U.S. Application Data
(60) Provisional application No. 62/114,175, filed on Feb. 10, 2015.

(51) Int. Cl. A42B 3/22; G02B 27/01; G06T 19/00; A42B 3/04

(52) U.S. Cl. CPC A42B 3/221; A42B 3/042; A42B 3/0433; G02B 27/0172; G06T 19/006; G02B 2027/0141; G02B 2027/014; G02B 2027/0169

(57) ABSTRACT

A head mounted device includes a helmet and a substantially arc-shaped visor. The helmet has an augmented reality device disposed in a housing of the helmet. A first set of magnets is embedded and disposed along a periphery of a front portion of the helmet. The substantially arc-shaped visor has a top part and a bottom part. The top part is removably attached to the front portion of the helmet. A second set of magnets is embedded and disposed along a periphery of the top part of the visor to match the first set of magnets.

### REFERENCE TO RELATED APPLICATION

This application claims the benefit of priority of U.S. Provisional Application No. 62/114,175, filed Feb. 10, 2015, which is hereby incorporated by reference in its entirety.

### TECHNICAL FIELD

The subject matter disclosed herein generally relates to a removable face shield for a head mounted device. Specifically, the present disclosure addresses a removable face shield of a helmet for viewing augmented reality content.

### BACKGROUND

An augmented reality (AR) device can be used to generate and display data in addition to an image captured with the AR device. For example, AR is a live, direct, or indirect view of a physical, real-world environment whose elements are augmented by computer-generated sensory input such as sound, video, graphics or GPS data. With the help of advanced AR technology (e.g., adding computer vision and object recognition), the information about the surrounding real world of the user becomes interactive. Device-generated (e.g., artificial) information about the environment and its objects can be overlaid on the real world. The AR device may include a helmet with a face shield.

However, a user may not need to have the face shield of a helmet at all times. For example, the user may wish to remove the face shield where there is a need for an unobstructed view or when the user does not wish to be distracted or bothered by reflections from the face shield. The user cannot just remove the face shield without removing the entire helmet. A face shield may also need to be replaced much more often than other helmet components.

### BRIEF DESCRIPTION OF THE DRAWINGS

Some embodiments are illustrated by way of example and not limitation in the figures of the accompanying drawings.

FIG. 1 is a block diagram illustrating an example of a network suitable for a head mounted device system, according to some example embodiments.

FIG. 2 is a block diagram illustrating an example embodiment of modules (e.g., components) of a head mounted device.

FIG. 3 is a block diagram illustrating an example embodiment of modules (e.g., components) of a display controller.

FIG. 4 is a block diagram illustrating an example embodiment of modules (e.g., components) of a server.

FIG. 5 is a flowchart illustrating a method for operating a display of a head mounted device, according to an example embodiment.

FIG. 6A is a diagram illustrating a front view of a removable face shield of a helmet, according to some example embodiments.

FIG. 6B is a diagram illustrating a side view of a removable face shield of helmet, according to some example embodiments.

FIG. 7A is a diagram illustrating a front view of a helmet without a face shield, according to some example embodiments.

FIG. 7B is a diagram illustrating a side view of a helmet without a face shield, according to some example embodiments.

FIG. 8 is a diagram illustrating a bottom view of a helmet, according to some example embodiments.

FIG. 9 is a diagram illustrating a top view of a face shield, according to some example embodiments.

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems are directed to a retractable display surface of a head mounted device (HMD), Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, an HMD includes a helmet and a substantially arc-shaped visor. The helmet includes an AR device that is disposed in a housing of the helmet. A first set of magnets is embedded and disposed along a periphery of a front portion of the helmet. The substantially arc-shaped visor has a top part and a bottom part. The top part is removably attached to the front portion of the helmet. A second set of magnets is embedded and disposed along a periphery of the top part of the visor to match the first set of magnets.

The first set of magnets is aligned with and disposed adjacent to the second set of magnets in the visor. In one example embodiment, the first set of magnets is disposed in alternating polarities along the periphery of the front portion of the helmet. The second set of magnets is disposed in alternating polarities along the periphery of the top part of the visor. The polarities of the first set of magnets are opposite to the polarities of the second set of magnets. A periphery of the bottom part and side parts of the visor is exposed and unconnected to the helmet. The visor comprises a transparent face shield for covering the eyes of a wearer of the helmet.

In one example embodiment, the first set of magnets is disposed in a recessed position within a surface of the top front of the helmet. The second set of magnets is disposed in a protruding position from a surface of the top part of the visor. In another example embodiment, the first set of magnets is disposed in a protruding position from a surface of the top front of the helmet, wherein the second set of magnets is disposed in a recessed position within a surface of the top part of the visor. In yet another example embodiment, the first set of magnets is disposed in a flush position along a surface of the top front of the helmet. The second set of magnets is disposed in a flush position along a surface of the top part of the visor.

In another embodiment, the HMD optionally includes a sensor embedded in a surface of the periphery of the front portion of the helmet. The sensor is connected to the AR device and configured to detect a presence of the visor when the visor is connected to the helmet. For example, the sensor comprises a magnetic switch sensor. The visor comprises a metallic component disposed in the periphery of the visor to connect with the magnetic switch sensor.

The AR device comprises at least one display lens mounted to the housing of the helmet. The AR device also includes at least one hardware processor comprising an AR module configured to cause the at least one display lens to display AR content.

Optionally, the AR module causes the at least one display lens to display AR content in response to the visor being connected to the helmet. The AR module causes the at least one display lens to hide the AR content in response to the visor being disconnected from the helmet.

The AR device includes a computing device such as a hardware processor with an AR application that allows the user wearing the helmet to experience information, such as in the form of a virtual object such as a three-dimensional (3D) virtual object overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user see through the display lens. The display lens may be part of the visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience the visualization of the additional information overlaid on top of a view or an image of any object in the real physical world. The virtual object may include a 3D virtual object, or a two-dimensional (2D) virtual object. For example, the 3D virtual object may include a 3D view of an engine part or an animation. The 2D virtual object may include a 2D view of a dialog box, a menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet, or other inputs from other devices, such as a wearable device. For example, the display lenses may extend or retract based on a voice command of the user, a gesture of the user, or a position of a watch in communication with the helmet.

In another example embodiment, a non-transitory machine-readable storage device may store a set of instructions that, when executed by at least one processor, causes the at least one processor to perform the method operations discussed within the present disclosure.

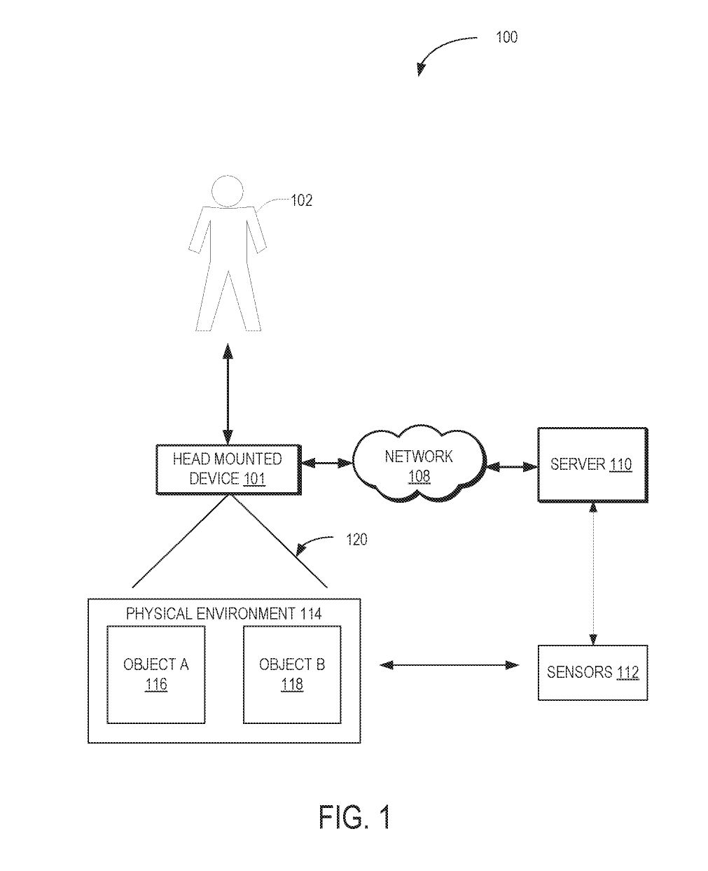

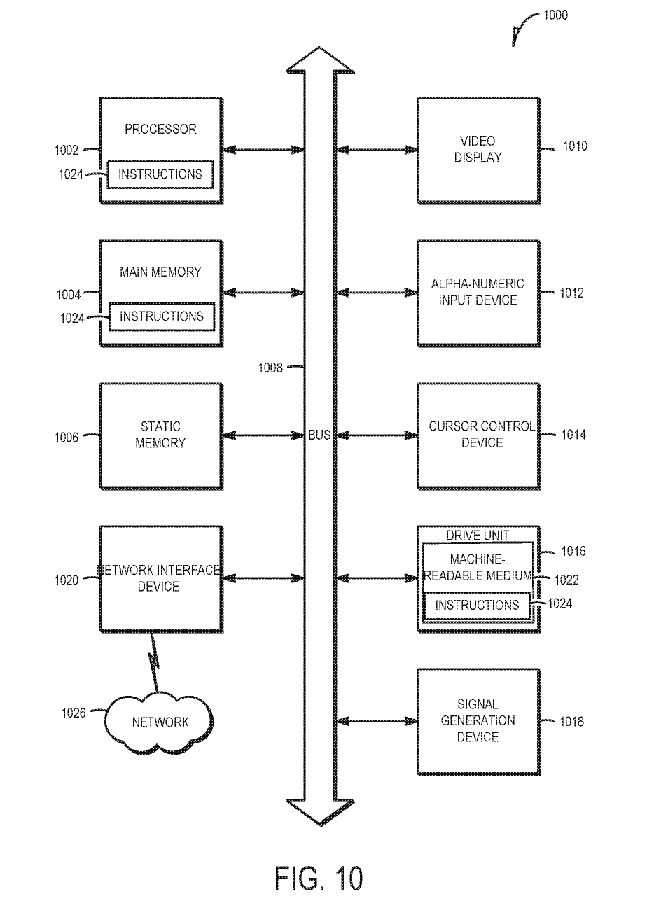

FIG. 1 is a network diagram illustrating a network environment 100 suitable for operating an AR application of an HMD with retractable display lenses, according to some example embodiments. The network environment 100 includes an HMD 101 and a server 110, communicatively coupled to each other via a network 108. The HMD 101 and the server 110 may each be implemented in a computer system, in whole or in part, as described below with respect to FIG. 10.

The server 110 may be part of a network-based system. For example, the network-based system may be or include a cloud-based server system that provides AR content (e.g., augmented information including 3D models of virtual objects related to physical objects captured by the HMD 101) to the HMD 101.

The HMD 101 may include a helmet that a user 102 may wear to view the AR content related to captured images of several physical objects (e.g., an object A 116, an object B 118) in a real-world physical environment 114. In one example embodiment, the HMD 101 includes a computing device with a camera and a display (e.g., smart glasses, smart helmet, smart visor, smart face shield, smart contact lenses). The computing device may be removably mounted to the head of the user 102. In one example, the display may be a screen that displays what is captured with a camera of the HMD 101. In another example, the display of the HMD 101 may be a transparent or semi-transparent surface such as the visor or face shield of a helmet, or a display lens distinct from the visor or face shield of the helmet.

The user 102 may be a user of an AR application in the HMD 101 and at the server 110. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101. The AR application may provide the user 102 with an AR experience triggered by identified objects in the physical environment 114. The physical environment 114 may include identifiable objects such as a 21) physical object (e.g., a picture), a 3D physical object (e.g., a factory machine), a location (e.g., at the bottom floor of a factory), or any references (e.g., perceived corners of walls or furniture) in the physical environment 114. The AR application may include computer vision recognition to identify corners, objects, lines, and letters. The user 102 may point the camera of the HMD 101 to capture an image of the objects 116 and 118 in the physical environment 114.

In one example embodiment, the objects in the image are tracked and recognized locally in the HMD 101 using a local context recognition dataset or any other previously stored dataset of the AR application of the HMD 101. The local context recognition dataset module may include a library of virtual objects associated with real-world physical objects or references. In one example, the HMD 101 identifies feature points in an image of the objects 116, 118 to determine different planes (e.g., edges, corners, surface, dial, (etters). The HMD 101 may also identify tracking data related to the objects 116, 118 (e.g., GPS location of the HMD 101, orientation, distances to the objects 116, 118), lithe captured image is not recognized locally at the HMD 101, the HMD 101 can download additional information (e.g., 3D model or other augmented data) corresponding to the captured image, from a database of the server 110 over the network 108.

In another embodiment, the objects 116, 118 in the image are tracked and recognized remotely at the server 110 using a remote context recognition dataset or any other previously stored dataset of an AR application in the server 110. The remote context recognition dataset module may include a library of virtual objects or augmented information associated with real-world physical objects or references.

Sensors 112 may be associated with, coupled to, or related to the objects 116 and 118 in the physical environment 114 to measure a location, information, or a reading of the objects 116 and 118. Examples of measured readings may include but are not limited to weight, pressure, temperature, velocity, direction, position, intrinsic and extrinsic properties, acceleration, and dimensions. For example, the sensors 112 may be disposed throughout a factory floor to measure movement, pressure, orientation, and temperature. The server 110 can compute readings from data generated by the sensors 112. The server 110 can generate virtual indicators such as vectors or colors based on data from the sensors 112. Virtual indicators are then overlaid on top of a live image of the objects 116 and 118 to show data related to the objects 116 and 118. For example, the virtual indicators may include arrows with shapes and colors that change based on real-time data. A visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is visually perceived as displayed adjacent to the objects 116 and 118).

The sensors 112 may include other sensors used to track the location, movement, and orientation of the HMD 101 externally without having to rely on the sensors internal to the HMD 101. The sensors 112 may include optical sensors (e.g., depth-enabled 3D camera, wireless sensors Bluetooth, Wi-Fi), GPS sensors, and audio sensors to determine the location of the user 102 having the HMD 101, a distance of the user 102 to the sensors 112 in the physical environment 114 (e.g., sensors placed in corners of a venue or a room), the orientation of the HMD 101 to track what the user 102 is looking at (e.g., direction at which the HMD 101 is pointed: HMD 101 pointed towards a player on a tennis court, HMD 101 pointed at a person in a room).

In another embodiment, data from the sensors 112 and internal sensors in the HMD 101 may be used for analytics data processing at the server 110 (or another server) for analysis of usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., whether the user 102 tapped on a link in the virtual object), and any suitable combination thereof. The HMD 101 receives a visualization content dataset related to the analytics data. The HMD 101 then generates a virtual object with additional visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., HMD 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

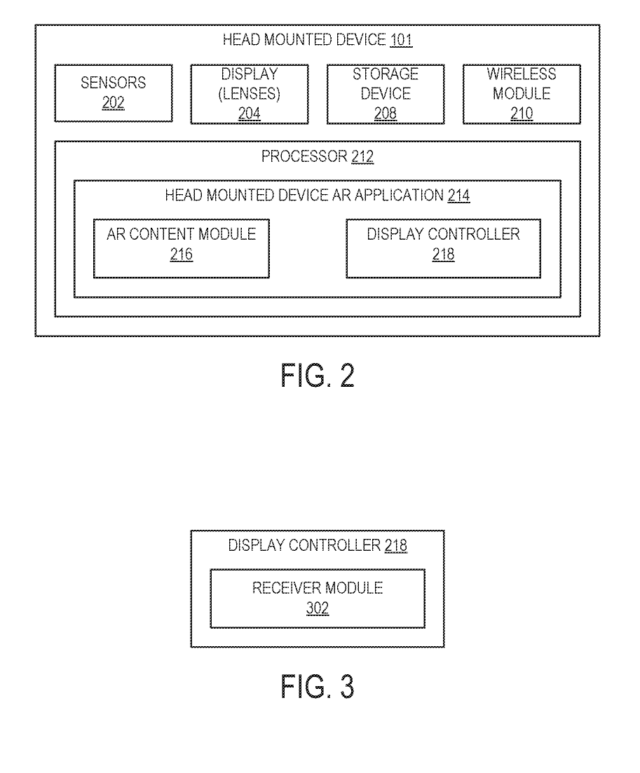

FIG. 2 is a block diagram illustrating modules (e.g., components) of the HMD 101, according to some example embodiments. The HMD 101 may be no helmet that includes sensors 202, a display 204, a storage device 208, a wireless module 210, and a processor 212.

The sensors 202 may include, for example, a proximity or location sensor (e.g., Near Field Communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof. For example, the sensors 202 may include rear-facing camera(s) and front-facing camera(s) disposed in the HMD 101. The sensors 202 described herein are for illustration purposes. The sensors 202 are thus not limited to the ones described. The sensors 202 may be used to generate internal tracking data of the HMD 101 to determine what the HMD 101 is capturing or looking at in the real physical world. For example, a virtual menu may be activated when the sensors 202 indicate that the HMD 101 is oriented downward (e.g., when the user tilts his head to watch his wrist).

The sensors 202 may include a magnetic or mechanical switch sensor to detect whether a face shield or visor is connected to the HMD 101.

The display 204 may include a display surface or lens capable of displaying AR content (e.g., images, video) generated by the processor 212. In another embodiment, the display 204 may also include a touchscreen display configured to receive a user input via a contact on the touchscreen display. In another example, the display 204 may be transparent or semi-transparent so that the user 102 can see through the display 204 (e.g., a Head-Up Display).

The storage device 208 may store a database of identifiers of wearable devices capable of communicating with the HMD 101. In another embodiment, the database may also include visual references (e.g., images) and corresponding experiences (e.g., 3D virtual objects, interactive features of the 3D virtual objects). The database may include a primary content dataset, and a contextual content dataset. The primary content dataset includes, for example, a first set of images and corresponding experiences (e.g., interactions with 3D virtual object models). For example, an image may be associated with one or more virtual object models. The primary content dataset may include a core set of images or the most popular images, as determined by the server 110. The core set of images may include a limited number of images identified by the server 110. For example, the core set of images may include images depicting covers of the ten most viewed devices and their corresponding experiences (e.g., virtual objects that represent the ten most viewed sensing devices in a factory floor). In another example, the server 110 may generate the first set of images based on the most popular or often scanned images received at the server 110. Thus, the primary content dataset does not depend on objects or images scanned by the HMD 101.

The contextual content dataset includes, for example, a second set of images and corresponding experiences (e.g., three-dimensional virtual object models) retrieved from the server 110. For example, images captured with the HMD 101 that are not recognized e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the context in which the HMD 101 has been used. As such, the contextual content dataset depends on objects or images scanned by the HMD 101.

In one embodiment, the HMD 101 may communicate over the network 108 with the server 110 to retrieve a portion of a database of visual references, corresponding 3D virtual objects, and corresponding interactive features of the 3D virtual objects.

The wireless module 210 comprises a component to enable the HMD 101 to communicate wirelessly with other machines, such as the server 110. The wireless module 210 may operate using Wi-Fi, Bluetooth, and other wireless communication means.

The processor 212 may include an HMD AR application 214 for generating a display of information related to the objects 116, 118. In one example embodiment, the HMD AR application 214 includes an AR content module 216 and a display controller 218. The AR content module 216 generates a visualization of information related to the objects 116, 118 when the HMD 101 captures an image of the objects 116, 118 and recognizes the objects 116, 118 or when the HMD 101 is in proximity to the objects 116, 118. For example, the HMD AR application 214 may generate a display of a holographic or virtual menu visually perceived as a layer on the objects 116, 118. The display controller 218 is configured to control the display 204. For example, the display controller 218 controls an adjustable position of the display 204 in the HMD 101 and controls a power supplied to the display 204.

In one example embodiment, the display controller 218 includes a receiver module 302 that communicates with a face shield sensor as illustrated in

FIG. 3. The receiver module 302 communicates with the sensors 202 in the HMD 101 to identify whether to activate (e.g., turn on) the display 204. For example, the receiver module 302 may detect that the face shield is connect to the HMD 101 and power on the display 204. In another example, the receiver module 302 detects that the face shield has been removed from the HMD 101 and turn off the display 204 in the HMD 101.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

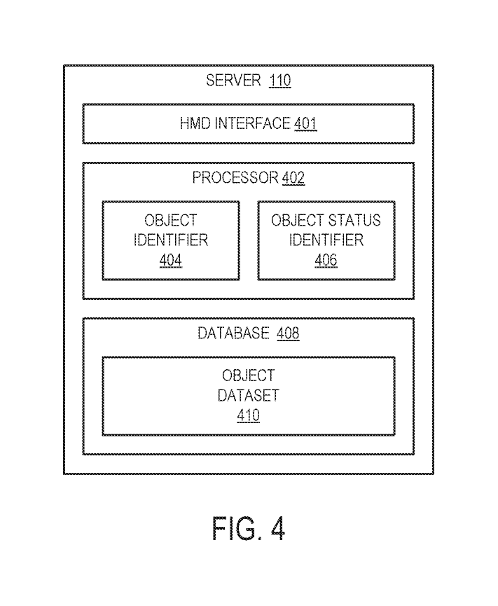

FIG. 4 is a block diagram illustrating modules (e.g., components) of the server 110. The server 110 includes an HMD interface 401, a processor 402, and a database 408. The HMD interface 401 may communicate with the HMD 101 and the sensors 112 (FIG. 1) to receive and send real-time data.

The processor 402 may include an object identifier 404 and an object status identifier 406. The object identifier 404 may identify the objects 116, 118 based on a picture or image frame received from the HMD 101. In another example, the HMD 101 already has identified the objects 116, 118 and has provided the identification information to the object identifier 404. The object status identifier 406 determines the physical characteristics associated with the objects identified. For example, if the object is a gauge, the physical characteristics may include functions associated with the gauge, a location of the gauge, a reading of the gauge, other devices connected to the gauge, or safety thresholds or parameters for the gauge. AR content may be generated based on the object identified and a status of the object.

The database 408 may store an object dataset 410. The object dataset 410 may include a primary content dataset and a contextual content dataset. The primary content dataset comprises a first set of images and corresponding virtual object models. The contextual content dataset may include a second set of images and corresponding virtual object models.

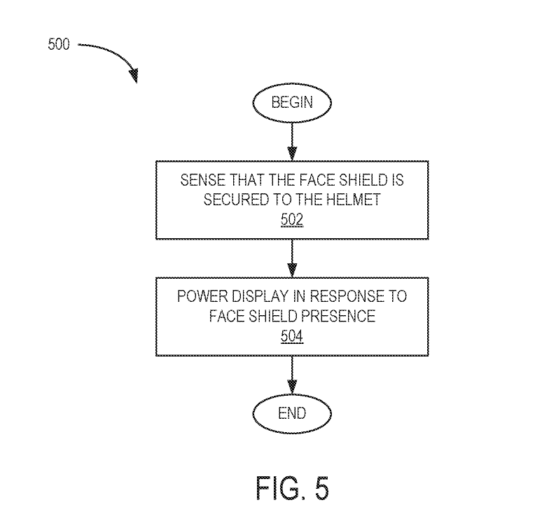

FIG. 5 is a flow diagram illustrating an example embodiment of a method 500 for operating the HMD 101. At operation 502, the HMD 101 senses that the face shield is secured to the helmet using a magnetic sensor or mechanical switch. At operation 504, the HMD powers the display in response to detecting that the face shield is connected to the helmet.

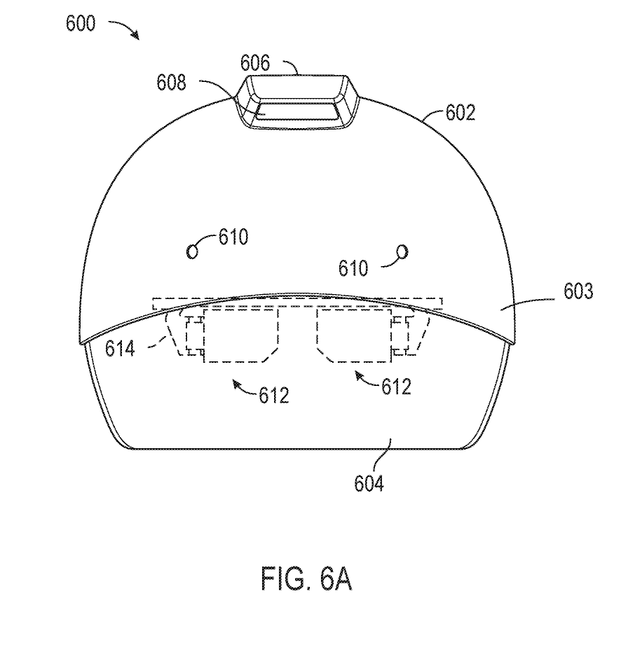

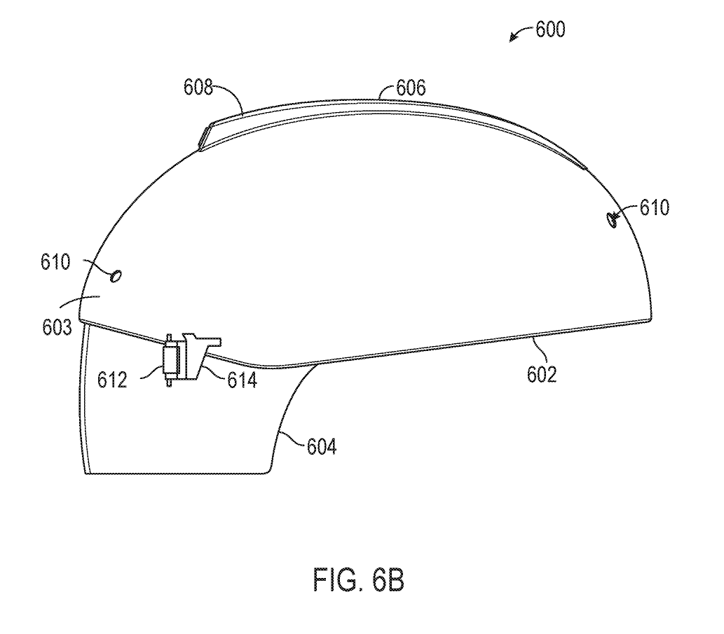

FIGS. 6A and 6B are diagrams illustrating a front and side view of a face shield connected to a helmet suitable for viewing AR content, according to some example embodiments. An HMD 600 (e.g., the HMD 101 of FIGS. 1 and 2) includes a helmet 602 connected to a visor 604.

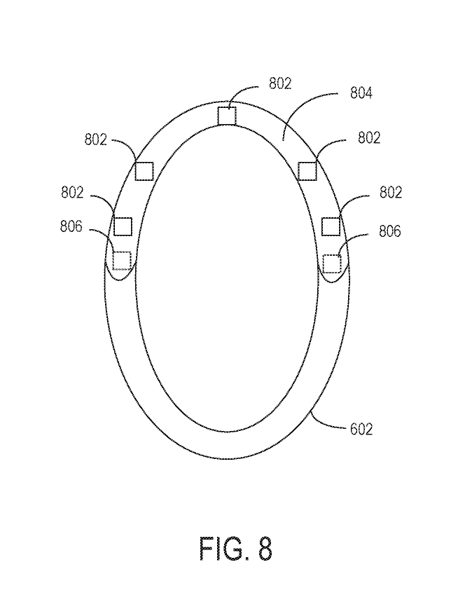

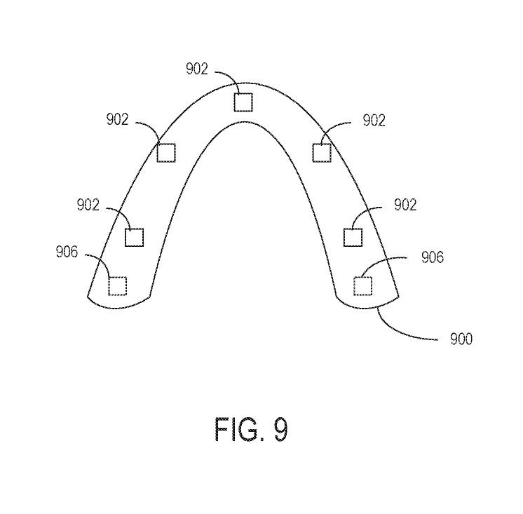

The visor 604 may include a shatterproof and transparent material such as Plexiglas. The visor 604 has a substantially arced shape to fit with a bottom portion 603 of the helmet 602. The visor 604 is connected to the helmet 602 via a plurality of magnets disposed inside both the visor 604 and the helmet 602. For example, a first set of magnets (shown in FIG. 8) is disposed in alternating polarities along the periphery of the bottom portion 603 of the helmet 602. A second set of magnets (shown in FIG. 9) is disposed in alternating polarities along the periphery of the top part of the visor 604. The polarities of the first set of magnets are opposite to the polarities of the second set of magnets so that the visor 604 snaps into place with the bottom portion 603 of the helmet 602. The bottom edges and side edges of the visor 604 are left exposed and unconnected to the helmet 602.

In one example embodiment, the first set of magnets is disposed in a recessed position within a surface of the bottom portion 603 of the helmet 602. The second set of magnets is disposed in a protruding position from a surface of the top part of the visor 604.

In another example embodiment, the first set of magnets is disposed in a protruding position from a surface of the bottom portion 603 of the helmet 602. The second set of magnets is disposed in a recessed position within a surface of the top part of the visor 604.

In another example embodiment, the first set of magnets is disposed in a flush position along a surface of the bottom portion 603 of the helmet 602. The second set of magnets is disposed in a flush position along a surface of the top part of the visor 604.

The helmet 602 may include sensors (e.g., optical or audio sensors) 608 and 610 disposed in the front, back, and a top section 606 of the helmet 602 Display lenses 612 are mounted on a lens frame 614. The display lenses 612 may include the display 204 of FIG. 2. The lens frame 614 can move up and down between a hidden position (e.g., raised position) within a cavity of the helmet 602 and an exposed position (e.g., lowered position) outside the cavity of the helmet 602. FIGS. 6A and 61B illustrate the lens frame 614 in the exposed position.

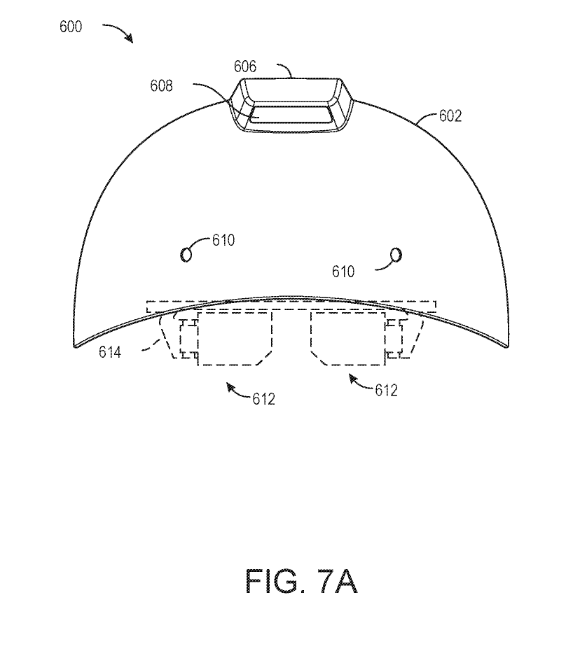

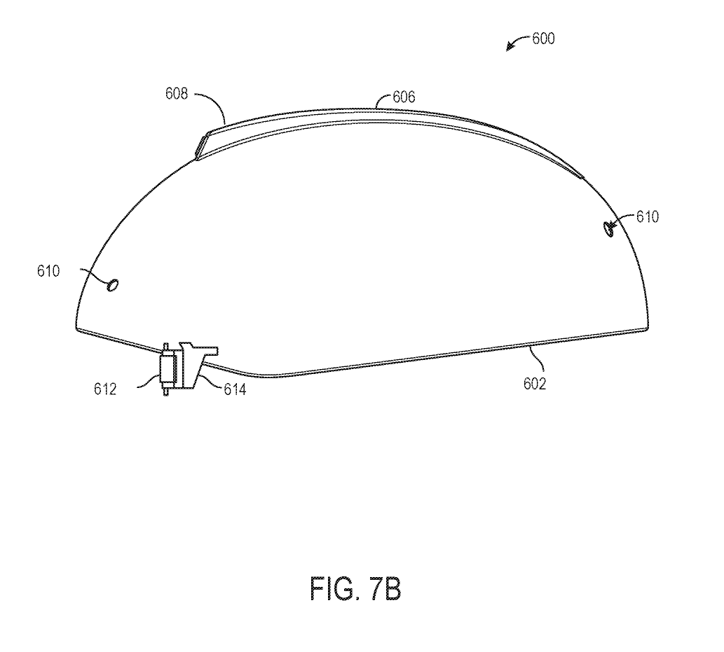

FIGS. 7A and 7B are diagrams illustrating a front and side view of the helmet 602 without a face shield, suitable for viewing AR content, according to some example embodiments. The HMD 600 includes the helmet 602 without the visor 604. As such, the display lenses 612 are left exposed.

FIG. 8 is a diagram illustrating a bottom view of the helmet 602. A first set of magnets 802 is disposed within an edge 804 of the bottom portion 603 of the helmet 602. The edge 804 may have a thickness similar to that of top part of the visor 604. Sensors 806 may be optionally embedded in the edge 804 of the bottom portion 603 of the helmet 602.

FIG. 9 is a diagram illustrating a top view of the face shield 900 (e.g., the visor 604 of FIGS. 6A and 6B). The second set of magnets 902 is disposed within an edge of the top portion of the face shield 900. The locations of the second set of magnets 902 correspond to the locations of the first set of magnets 802. Sensors 906 may optionally be embedded in the top portion of the face shield 900.

### Modules, Components and Logic

Certain embodiments are described herein as including logic or a number of components, modules, or mechanisms. Modules may constitute either software modules code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system or one or more hardware modules of a computer system (e.g., a processor or a group of processors) may he configured by software e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location e.g., within a home environment, an office environment, or a server (arm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces

### Electronic Apparatus and System

Example embodiments may be implemented in digital electronic circuitry, or in computer hardware, firmware, ors or in combinations of them. Example embodiments may be implemented using a computer program product, e.g., a computer program tangibly embodied in an information carrier; e.g., in a machine-readable medium for execution by, or to control the operation of, data processing apparatus, e.g.; a programmable processor, a computer; or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may he implemented as, special purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 10 is a block diagram of a machine in the example form of a computer system 1000 within which instructions 1024 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a disk drive unit 1016, a signal generation device 1018 (e.g., a speaker), and a network interface device 1020.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. The instructions 1024 may also reside, completely, or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, plain old telephone service (POTS) networks, and wireless data networks WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings, which form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed. Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A head mounted device comprising:
a helmet comprising an augmented reality device that is disposed in a housing of the helmet;
a first set of magnets embedded and disposed along a periphery of a front portion of the helmet;
a substantially arc-shaped visor having a top part and a bottom part, the top part removably attached to the front portion of the helmet; and
a second set of magnets embedded and disposed along a periphery of the top part of the visor to match the first set of magnets.

2. The head mounted device of claim 1, wherein the first set of magnets is aligned with the second set of magnets.

3. The head mounted device of claim 1, wherein the first set of magnets in the helmet is disposed adjacent to the second set of magnets in the visor.

4. The head mounted device of claim 2, wherein the first set of magnets is disposed in alternating polarities along the periphery of the front portion of the helmet, and wherein the second set of magnets is disposed in alternating polarities along the periphery of the top part of the visor, the polarities of the first set of magnets opposite to the polarities of the second set of magnets.

5. The head mounted device of claim 1, wherein a periphery of the bottom part and side parts of the visor is exposed and unconnected to the helmet.

6. The head mounted device of claim 1, wherein the visor comprises a transparent face shield for covering eyes of a wearer of the helmet.

7. The head mounted device of claim 1, wherein the first set of magnets is disposed in a recessed position within a surface of the front portion of the helmet, and wherein the second set of magnets is disposed in a protruding position from a surface of the top part of the visor.

8. The head mounted device of claim 1, wherein the first set of magnets is disposed in a protruding position from a surface of the front portion of the helmet, and wherein the second set of magnets is disposed in a recessed position within a surface of the top part of the visor.

9. The head mounted device of claim 1, wherein the first set of magnets is disposed in a flush position along a surface of the front portion of the helmet, and wherein the second set of magnets is disposed in a flush position along a surface of the top part of the visor.

10. The head mounted device of claim 1, further comprising a sensor embedded in a surface of the periphery of the front portion of the helmet, the sensor connected to the augmented reality device and configured to detect a presence of the visor when the visor is connected to the helmet.

11. The head mounted device of claim 10, wherein the sensor comprises a magnetic switch sensor, and wherein the visor comprises a metallic component disposed in a periphery of the visor to connect with the magnetic switch sensor.

12. The head mounted device of claim 11, wherein the augmented reality device further comprises:
at least one display lens mounted to the housing of the helmet, the at least one display lens being transparent; and
at least one hardware processor comprising an augmented reality module configured to cause the at least one display lens to display augmented reality content based on the magnetic switch sensor.

13. The head mounted device of claim 12, wherein the augmented reality module causes the at least one display lens to display the augmented reality content in response to the visor being connected to the helmet, and causes the at least one display lens to hide the augmented reality content in response to the visor being disconnected from the helmet.

14. The head mounted device of claim 1, wherein the augmented reality device further comprises:
an audio sensor; and
an optical sensor.

15. A method comprising:
detecting that a face shield is connected to a helmet,
the helmet comprising an augmented reality device disposed in a housing of the helmet, a first set of magnets embedded and disposed along a periphery of a front portion of the helmet,
the face shield comprising a substantially arc-shaped visor having a top part and a bottom part, the top part removably attached to the front portion of the helmet, a second set of magnets embedded and disposed along a periphery of the top part of the visor to match the first set of magnets; and
causing at least one display lens of the augmented reality device to display augmented reality content in response to detecting that the face shield is connected to the helmet.

16. The method of claim 15, wherein the first set of magnets is aligned with the second set of magnets.

17. The method of claim 15, wherein the first set of magnets is disposed in a recessed position within a surface of the front portion of the helmet, and wherein the second set of magnets is disposed in a protruding position from a surface of the top part of the visor.

18. The method of claim 15, wherein the first set of magnets is disposed in a protruding position from a surface of the front portion of the helmet, and wherein the second set of magnets is disposed in a recessed position within a surface of the top part of the visor.

19. The method of claim 15, wherein the first set of magnets is disposed in a flush position along a surface of the front portion of the helmet, and wherein the second set of magnets is disposed in flush position along a surface of the top part of the visor.

20. The method of claim 15, wherein the helmet comprises a sensor embedded in a surface of the periphery of the front portion of the helmet, the sensor connected to an augmented reality device in the helmet and configured to detect a presence of the visor when the visor is connected to the helmet, and
wherein the method further comprises:
displaying augmented reality content in a transparent display lens of the helmet in response to detecting that the visor being connected to the helmet using the sensor.
